(19) United States
(12) Patent Application Publication
(10) Pub. No.: US 2022/0082480 A1
(43) Pub. Date: Mar. 17, 2022

(54) SMEAR PREPARATION MACHINE AND SAMPLE STAINING METHOD

(71) Applicant: SHENZHEN MINDRAY BIO-MEDICAL ELECTRONICS CO., LTD., Shenzhen (CN)

(72) Inventors: Yingming LIU, Shenzhen (CN); Fuxing LAI, Shenzhen (CN); Jin TENG, Shenzhen (CN)

(21) Appl. No.: 17/536,902

(22) Filed: Nov. 29, 2021

Related U.S. Application Data
(63) Continuation of application No. PCT/CN2019/092513, filed on Jun. 24, 2019.

(51) Int. Cl. G01N 1/31; G01N 35/00

(52) U.S. Cl. CPC G01N 1/312; G01N 2001/302; G01N 35/00029

(57) ABSTRACT

A smear preparation machine includes: a slide loading mechanism (2) configured to load a slide; a sample applying mechanism (3) configured to apply a blood sample to the slide; a smearing mechanism (4) configured to smear the blood sample on the slide to prepare a smear; a dripping and staining mechanism (5) configured to drip a staining reagent and a buffer solution to the smear; an air blowing mechanism configured to blow air to the staining reagent and the buffer solution on the smear for blowing mixing, such that the staining reagent and the buffer solution are mixed and cover the smear, thereby staining the smear once.

### CROSS-REFERENCE TO RELATED APPLICATIONS

This application is a continuation of International Application No. PCT/CN2019/092513, filed Jun. 24, 2019, the content of which is incorporated herein by reference.

### TECHNICAL FIELD

Embodiments of the disclosure relate to the technical field of medical detection, and in particular to a smear preparation machine and a sample staining method.

### BACKGROUND

Sample staining is an important step in the process of sample detection and analysis. Taking blood smears as an example, traditional blood smear staining methods are typically completed manually, which is inefficient. Therefore, numerous automated staining instruments have appeared at present. Such automated staining instruments generally use a vertical dip-staining mode, the staining process of which generally simulates manual operation. In general, in a small container, a blood film is fixed in advance by means of a pure staining reagent, and mixed liquid of a staining reagent and a buffer solution is then prepared according to a certain proportion to dip the blood smear. However, in the prior art, using a dripping and staining mode to stain a smear still depends on manual operation, and non-uniform staining is prone to occur.

### SUMMARY

In order to solve the above technical problems, embodiments of the disclosure aim to provide a smear preparation machine and a sample staining method. The smear preparation machine can use a dripping and staining mode to stain a sample. Furthermore, an air blowing mechanism of the smear preparation machine can allow staining liquid to be mixed uniformly and completely cover a smear, thereby realizing uniform staining.

The technical solutions of the embodiments of the disclosure may be implemented as follows.

An embodiment of the disclosure provides a smear preparation machine, comprising: a slide loading mechanism configured to load a slide, a sample applying mechanism configured to apply a blood sample onto the slide, a smearing mechanism configured to smear the blood sample on the slide to prepare a smear, a dripping and staining mechanism configured to drip a staining reagent and a buffer solution to the smear, and an air blowing mechanism configured to blow air to the staining reagent and the buffer solution on the smear for blowing mixing, such that the staining reagent and the buffer solution are mixed and cover the smear to perform staining on the smear.

In an embodiment of the above smear preparation machine, the air blowing mechanism comprises an air source, a blowing mixing component and an air blowing control valve, wherein the air blowing control valve is connected to the air source and the blowing mixing component respectively; wherein the air source is configured to provide an airflow; and the blowing mixing component is configured to blow the airflow provided by the air source to the staining reagent and the buffer solution to perform the blowing mixing when the air blowing control valve is opened.

In an embodiment of the above smear preparation machine, the blowing mixing component comprises at least one air inlet, at least one airflow pipeline, and a plurality of air blowing ports, wherein the plurality of air blowing ports are provided on the at least one airflow pipeline; the at least one air inlet is connected to the air blowing control valve and the at least one airflow pipeline respectively, the at least one air inlet is configured to receive the airflow when the air blowing control valve is opened, so as to cause the airflow to flow to the at least one airflow pipeline; and the plurality of air blowing ports are configured to blow the airflow, which enters into the at least one airflow pipeline, to the staining reagent and the buffer solution on the smear.

In an embodiment of the above smear preparation machine, the blowing mixing component further comprises a main body, the at least one airflow pipeline comprises a plurality of airflow pipelines, each airflow pipeline corresponds to one air inlet, and each air inlet is provided outside the main body in a horizontal direction; the plurality of airflow pipelines are provided inside the main body side-by-side in the horizontal direction, and pipeline bottom ends corresponding to the plurality of airflow pipelines are confined inside the main body; and the plurality of air blowing ports are uniformly provided on the plurality of airflow pipelines, and face and extend through a same horizontal side face of the main body.

In an embodiment of the above smear preparation machine, the air blowing mechanism further comprises a motion control component connected to the blowing mixing component, and the motion control component is configured to control the blowing mixing component to rotate about an axis of the blowing mixing component itself and/or perform a translational movement in the horizontal direction.

In an embodiment of the above smear preparation machine, the motion control component is configured to control the blowing mixing component to rotate 60-150 degrees.

In an embodiment of the above smear preparation machine, the dripping and staining mechanism comprises a first control valve, a first reagent bottle, a second control valve, a second reagent bottle and a reagent needle, wherein the first control valve is connected to the first reagent bottle and the reagent needle respectively, and the second control valve is connected to the second reagent bottle and the reagent needle respectively; and the reagent needle is configured to drip the staining reagent from the first reagent bottle when the first control valve is opened, and to drip the buffer solution from the second reagent bottle when the second control valve is opened.

In an embodiment of the above smear preparation machine, the dripping and staining mechanism comprises a first control valve, and a first reagent bottle and a first reagent needle which are connected to the first control valve, the first reagent needle being configured to drip the staining reagent from the first reagent bottle when the first control valve is opened; and the dripping and staining mechanism further comprises a second control valve, and a second reagent bottle and a second reagent needle which are connected to the second control valve, the second reagent needle being configured to drip the buffer solution from the second reagent bottle when the second control valve is opened.

In an embodiment of the above smear preparation machine, the staining reagent comprises a first staining reagent, and a mixed staining reagent formed by mixing a second staining reagent and the buffer solution; and the smear preparation machine further comprises a liquid removing mechanism; wherein the liquid removing mechanism is configured to remove the first staining reagent and the buffer solution from the smear, after the dripping and staining mechanism performs a first staining on the smear by using the first staining reagent and the buffer solution; and the dripping and staining mechanism is further configured to drip the mixed staining reagent to the smear to perform a second staining on the smear, after the liquid removing mechanism removes the first staining reagent and the buffer solution from the smear.

In an embodiment of the above smear preparation machine, the dripping and staining mechanism comprises a first control valve, a first reagent bottle, a second control valve, a second reagent bottle, a third control valve, a third reagent bottle, and a reagent needle, wherein the first control valve is connected to the first reagent bottle and the reagent needle respectively, the second control valve is connected to the second reagent bottle and the reagent needle respectively, and the third control valve is connected to the third reagent bottle and the reagent needle respectively; and the reagent needle is configured to drip the first staining reagent from the first reagent bottle when the first control valve is opened, to drip the buffer solution from the second reagent bottle when the second control valve is opened, and to drip the mixed staining reagent from the third reagent bottle when the third control valve is opened.

In an embodiment of the above smear preparation machine, the dripping and staining mechanism comprises a first control valve, and a first reagent bottle and a first reagent needle which are connected to the first control valve, the first reagent needle being configured to drip the first staining reagent from the first reagent bottle when the first control valve is opened; the dripping and staining mechanism further comprises a second control valve, and a second reagent bottle and a second reagent needle which are connected to the second control valve, the second reagent needle being configured to drip the buffer solution from the second reagent bottle when the second control valve is opened; and the dripping and staining mechanism further comprises a third control valve, and a third reagent bottle and a third reagent needle which are connected to the third control valve, the third reagent needle being configured to drip the mixed staining reagent from the third reagent bottle when the third control valve is opened.

In an embodiment of the above smear preparation machine, the liquid removing mechanism is the air blowing mechanism or a flipping mechanism, wherein the air blowing mechanism comprises a liquid removing control valve, and an air source and an air blowing needle which are connected to the liquid removing control valve; the air blowing needle is configured to blow off the first staining reagent and the buffer solution from the smear by using an airflow provided by the air source when the liquid removing control valve is opened; and the flipping mechanism is connected to the slide loading mechanism for flipping the slide loading mechanism to cause the first staining reagent and the buffer solution to drip off from the smear.

In an embodiment of the above smear preparation machine, the smear preparation machine further comprises: a washing mechanism configured to use deionized water to wash the stained smear, and a drying mechanism configured to air-dry the smear after being washed.

In an embodiment of the above smear preparation machine, the washing mechanism comprises: a deionized water module configured to provide the deionized water, a washing needle configured to output the deionized water to wash the stained smear, and a washing control valve configured to control the flowing of the deionized water to the washing needle, wherein the washing control valve is connected to the deionized water module and the washing needle respectively.

An embodiment of the disclosure provides a sample staining method applicable to a smear preparation machine, the method comprising: loading a slide by a slide loading mechanism; applying a blood sample onto the slide by a sample applying mechanism; smearing the blood sample on the slide to prepare a smear by a smearing mechanism; dripping a staining reagent and a buffer solution to the smear respectively by a dripping and staining mechanism, and blowing air to the staining reagent and the buffer solution on the smear for blowing mixing by an air blowing mechanism such that the staining reagent and the buffer solution are mixed to cover the smear to perform staining on the smear.

In an embodiment of the above method, after the blowing air to the staining reagent and the buffer solution on the smear for blowing mixing by an air blowing mechanism such that the staining reagent and the buffer solution are mixed to cover the smear to perform staining on the smear, the method further comprises: using deionized water to wash the stained smear by a washing mechanism, and air-drying, by a drying mechanism, the smear after being washed.

An embodiment of the disclosure provides a sample staining method applicable to a smear preparation machine, the method comprising: loading a slide by a slide loading mechanism; applying a blood sample onto the slide by a sample applying mechanism; smearing the blood sample on the slide to prepare a smear by a smearing mechanism; dripping a first staining reagent and a buffer solution to the smear by a dripping and staining mechanism; blowing air to the first staining reagent and the buffer solution on the smear for blowing mixing by an air blowing mechanism such that the first staining reagent and the buffer solution are mixed to cover the smear so as to perform a primary staining on the smear; removing the first staining reagent and the buffer solution from the smear by a liquid removing mechanism; and dripping a mixed staining reagent to the smear by the dripping and staining mechanism to perform a secondary staining on the smear.

In an embodiment of the above method, after the dripping a mixed staining reagent to the smear by the dripping and staining mechanism to perform a secondary staining on the smear, the method further comprises: using deionized water to wash the smear after being subjected to the secondary staining by a washing mechanism, and air-drying the smear after being washed by a drying mechanism.

An embodiment of the disclosure provides a smear preparation machine, comprising: a slide loading mechanism configured to load a slide, a sample applying mechanism configured to apply a blood sample onto the slide, a smearing mechanism configured to smear the blood sample on the slide to prepare a smear, a dripping and staining mechanism configured to drip a staining reagent and a buffer solution to the smear, and an air blowing mechanism configured to blow air to the staining reagent and the buffer solution on the smear for blowing mixing, such that the staining reagent and the buffer solution are mixed and cover the smear to perform staining on the smear.

The smear preparation machine provided by the embodiments of the disclosure can use a dripping and staining mode to stain a sample in a fully automated manner, so as to improve the staining efficiency. Furthermore, the air blowing mechanism of the smear preparation machine can allow staining liquid to be mixed uniformly and completely cover the smear, thereby realizing uniform staining to improve the staining effect.

### BRIEF DESCRIPTION OF THE DRAWINGS

FIG. 1 is a schematic structural diagram I of a smear preparation machine provided in an embodiment of the disclosure;

FIG. 2 is a schematic structural diagram II of the smear preparation machine provided in an embodiment of the disclosure;

FIG. 3 is a schematic diagram of an exemplary working process of a smear preparation machine provided in an embodiment of the disclosure;

FIG. 4 is a schematic structural diagram I of an air blowing mechanism provided in an embodiment of the disclosure;

FIG. 5 is a schematic structural diagram I of a blowing mixing component provided in an embodiment of the disclosure;

FIG. 6 is a schematic structural diagram II of a blowing mixing component provided in an embodiment of the disclosure;

FIG. 7 is a schematic structural diagram III of a blowing mixing component provided in an embodiment of the disclosure;

FIG. 8 is a longitudinal sectional view of a blowing mixing component provided in an embodiment of the disclosure;

FIG. 9 is a schematic structural diagram II of an air blowing mechanism provided in an embodiment of the disclosure;

FIG. 10 is a schematic diagram of the motion of a blowing mixing component provided in an embodiment of the disclosure;

FIG. 11 is a schematic structural diagram I of a dripping and staining mechanism provided in an embodiment of the disclosure;

FIG. 12 is a schematic structural diagram II of a dripping and staining mechanism provided in an embodiment of the disclosure;

FIG. 13 is a schematic structural diagram III of a dripping and staining mechanism provided in an embodiment of the disclosure;

FIG. 14 is a schematic structural diagram IV of a dripping and staining mechanism provided in an embodiment of the disclosure;

FIG. 15 is a schematic structural diagram of a liquid removing mechanism provided in an embodiment of the disclosure;

FIG. 16 is a schematic structural diagram of a washing mechanism provided in an embodiment of the disclosure;

FIG. 17 is a schematic diagram of a sample staining process performed by a smear preparation machine according to a first dripping and staining solution provided in an embodiment of the disclosure; and

FIG. 18 is a schematic diagram of a sample staining process performed by a smear preparation machine according to a second dripping and staining solution provided in an embodiment of the disclosure.

### DETAILED DESCRIPTION

The disclosure will be further described in detail below through specific implementations in conjunction with the accompanying drawings. Associated similar element reference numerals are used for similar elements in different implementations. In the following implementations, many details are described such that the disclosure can be better understood. However, it may be effortlessly appreciated by a person skilled in the art that some of the features may be omitted, or may be substituted by other elements, materials, and methods in different cases. In certain cases, some operations involved in the disclosure are not displayed or described in the specification, which is to prevent a core part of the disclosure from being obscured by too much description. Moreover, for a person skilled in the art, the detailed description of the involved operations is not necessary, and the involved operations can be thoroughly understood according to the description in the specification and the general technical knowledge in the art.

In addition, the characteristics, operations, or features described in the specification can be combined in any appropriate manner to form various implementations. Moreover, the steps or actions in the method description may also be exchanged or adjusted in order in a way that is obvious to a person skilled in the art. Therefore, the various orders in the specification and the accompanying drawings are merely for the purpose of clear description of a certain embodiment and are not meant to be a necessary order unless otherwise stated that a certain order must be followed.

The serial numbers themselves for the components herein, for example, “first” and “second”, are merely used to distinguish the described objects, and do not have any sequential or technical meaning. Moreover, as used in the disclosure, “connection” or “coupling”, unless otherwise specified, comprises both direct and indirect connections (couplings).

An embodiment provides a smear preparation machine, which can use a dripping and staining mode to stain a sample. Furthermore, the smear preparation machine can allow staining liquid to be mixed uniformly and completely cover a smear, thereby realizing uniform staining. In order to express the inventive concept of the disclosure more clearly, details are described as follows.

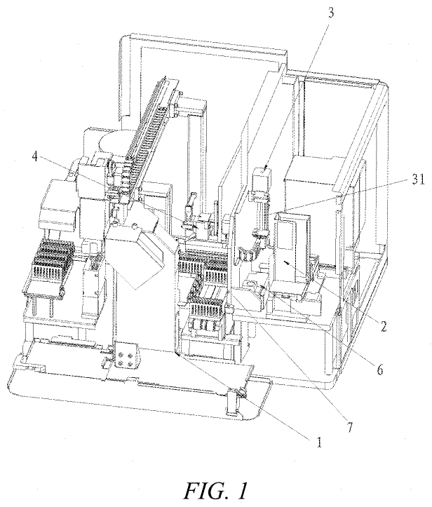

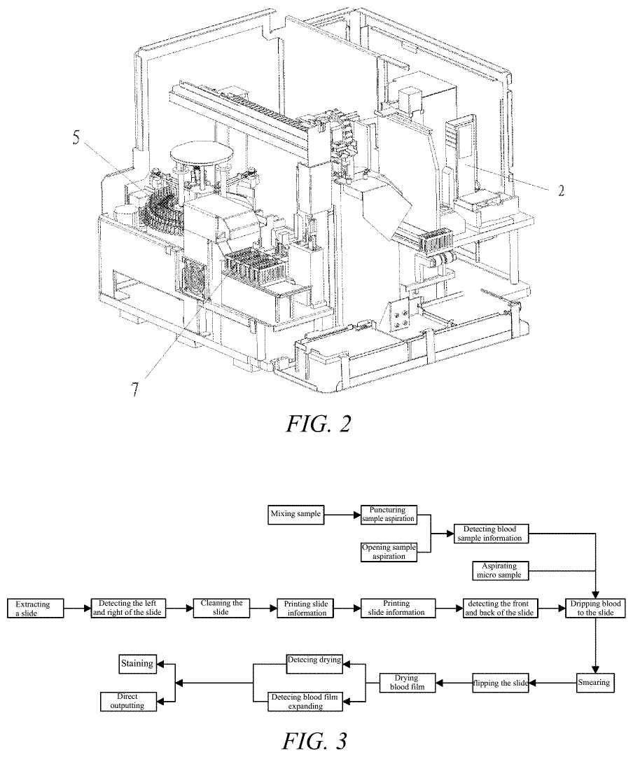

Referring to FIGS. 1 and 2, an embodiment provides a smear preparation machine, which may be used for preparing and staining a smear of a sample such as blood and body fluid. The smear preparation machine may comprise a sample extracting mechanism 1 configured to extract a sample, a slide loading mechanism 2 configured to load a slide, a sample applying mechanism 3 configured to apply a blood sample onto the slide, a smearing mechanism 4 configured to smear the blood sample on the slide to prepare a smear, a dripping and staining mechanism 5 configured to drip a staining reagent and a buffer solution to the smear, and an air blowing mechanism (not shown in the figures) configured to blow air to the staining reagent and the buffer solution on the smear for blowing mixing, such that the staining reagent and the buffer solution are mixed and cover the smear to perform staining on the smear.

Referring to FIGS. 1 to 3, in an embodiment, when the sample extracting mechanism 1 extracts a sample, the sample is mixed uniformly, and then the sample is aspirated by using a sampling device (for example, a sampling needle 31) in the sample extracting mechanism 1. Depending on different sample containers, the sample aspiration may be puncturing sample aspiration (the sample container has a cover, and the sampling device penetrates the cover of the sample container), or opening sample aspiration (the sample container is open, and the sampling device performs sample aspiration directly from an opening portion). When necessary, blood sample information detection may be performed to acquire and compare information. In some embodiments, a sample feeding mechanism 6 for small-amount samples is further comprised, the sample feeding mechanism 6 may move a test tube input by an operator directly in the direction of the sampling device, or the sampling device may also move in the direction of the test tube input by the operator. In other implementations, the sample feeding mechanism 6 may also move a test tube directly in the direction of the sample applying mechanism 3, or the sample applying mechanism 3 may also move directly in the direction of the test tube put by the operator, a blood sample is aspirated directly by means of the sample applying mechanism 3 (for example, a blood dripping needle), and then the sample is applied, which may reduce the demand of the blood sample so as to realize the feeding of small-amount samples and preferential samples since there is no need to draw blood by the sample extracting mechanism 1. The sample applying mechanism 3 prepares to drip the blood onto the slide after the sample is extracted.

Accordingly, the slide loading mechanism 2 takes a slide and loads the slide to a corresponding position, to facilitate blood dripping operation. In some embodiments, after taking a slide and before loading the slide, an operation of detecting the left and right of the slide, an operation of cleaning the slide and other operations may also be performed. The loaded slide may be subjected to an operation of printing related information, an operation of detecting the front and back of the slide and other operations.

Continuing to refer to FIGS. 1 to 3, a blood dripping needle of the sample applying mechanism 3 drips a sample onto the slide and then a smearing operation is performed on the sample, in which blood is smeared by the smearing mechanism 4 to form a blood film shape on the slide, so as to prepare a smear. In general, after the smearing is completed, the blood film on the slide may be dried to stabilize the morphology of the blood film. As shown in FIG. 3, in some embodiments, the smear may be driven to flip before the blood film is dried, thereby meeting corresponding requirements. In some embodiments, drying detection may also be performed on the blood smear after being dried, so as to determine drying effect of the blood film. In some embodiments, blood film expanding detection may also be performed on the blood smear after being dried, so as to determine whether the blood film is expanded and whether the expanded state meets a requirement.

Continuing to refer to FIGS. 1 to 3, after smearing is completed, the slide (the blood smear) may be stained (which may be realized by means of the dripping and staining mechanism 5 and the air blowing mechanism) or be output directly (for example, be placed into a slide basket 7 for output).

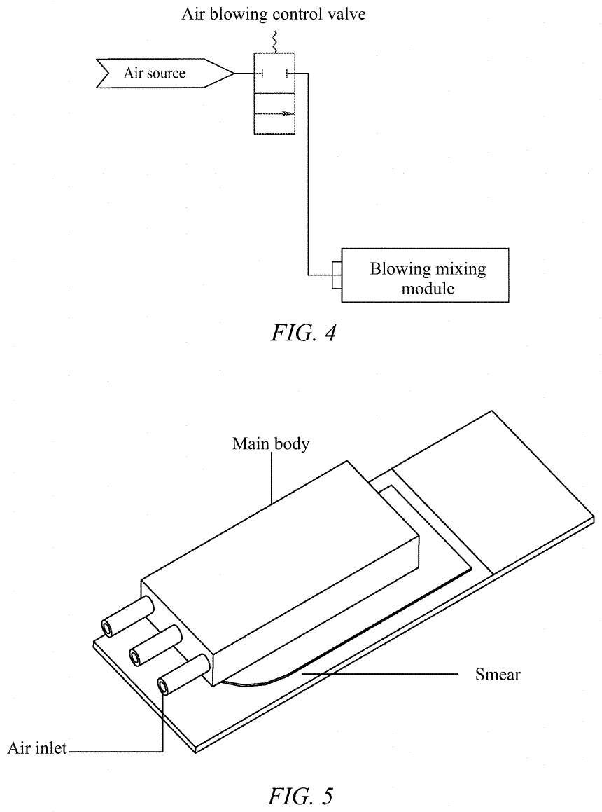

Referring to FIG. 4, the air blowing mechanism comprises an air source, a blowing mixing component and an air blowing control valve, wherein the air blowing control valve is connected to the air source and the blowing mixing component respectively. The air source is configured to provide an airflow; and the blowing mixing component is configured to blow the airflow provided by the air source to the staining reagent and the buffer solution to perform the blowing mixing when the air blowing control valve is opened.

It should be noted that in the embodiments of the disclosure, the air source may specifically be a device capable of providing an airflow, such as an air storage tank, an air cylinder, and a turbine. The air source is not specifically limited in the embodiments of the disclosure.

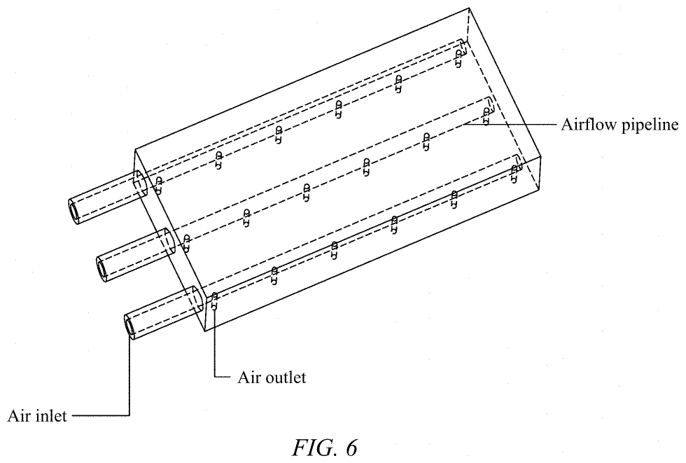

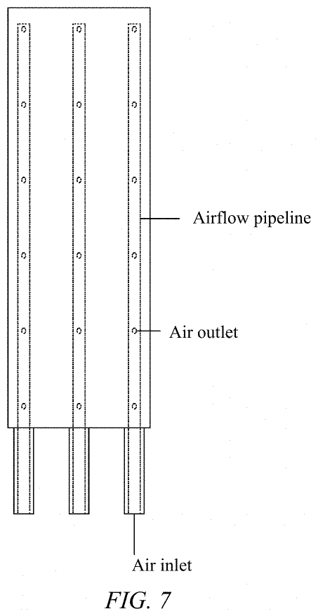

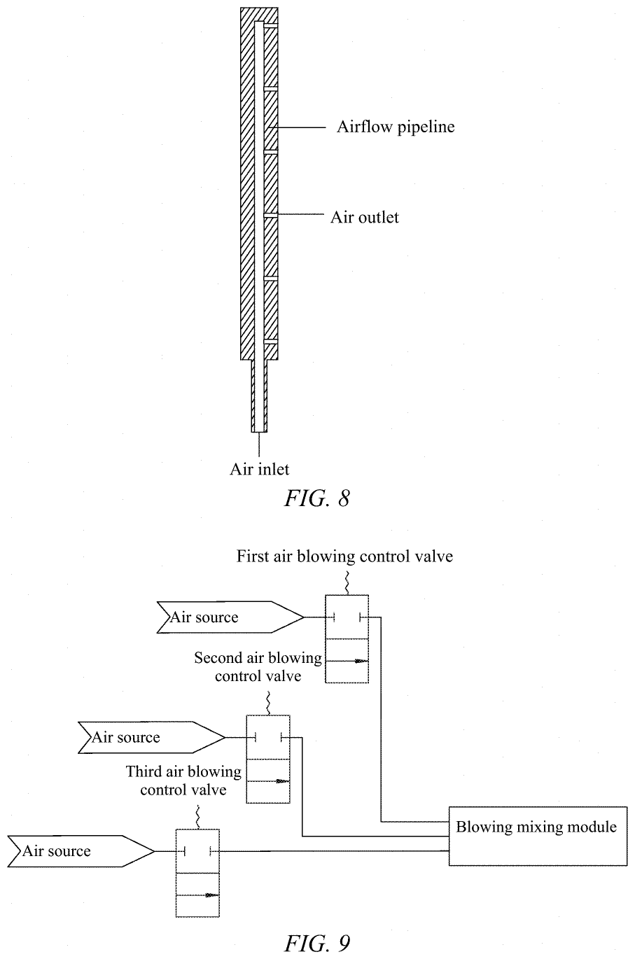

Referring to FIGS. 5 to 8, the blowing mixing component comprises at least one air inlet, at least one airflow pipeline, and a plurality of air blowing ports, wherein the plurality of air blowing ports are provided on the at least one airflow pipeline; the at least one air inlet is connected to the air blowing control valve and the at least one airflow pipeline respectively, the at least one air inlet is configured to receive the airflow when the air blowing control valve is opened, so as to cause the airflow to flow to the at least one airflow pipeline; and the plurality of air blowing ports are configured to blow the airflow, which enters into the at least one airflow pipeline, to the staining reagent and the buffer solution on the smear.

It may be understood that in the prior art, the staining reagent and the buffer solution on the slide are usually mixed in a balloon blowing manner, which may only realize local mixing, that is, mixing in an area corresponding to an air blowing port, and it is very difficult to realize mixing in a peripheral area of the slide, thereby influencing the staining effect of the slide. In an embodiment of the disclosure, the blowing mixing component comprises a plurality of air blowing ports which may actually correspond to different areas on the slide. When the air blowing control valve is opened, the airflow provided by the air source is blown to the corresponding areas on the slide from the plurality of air blowing ports of the blowing mixing component respectively, thereby not only uniformly mixing the staining reagent and the buffer solution, but also allowing a mixed liquid of the staining reagent and the buffer solution uniformly cover the whole slide, thereby improving the staining effect of the slide.

Continuing to refer to FIGS. 5 to 8, the blowing mixing component further comprises a main body, a plurality of airflow pipelines are provided, each of the airflow pipelines corresponds to one air inlet, and each of the air inlets is provided outside the main body in a horizontal direction; the plurality of airflow pipelines are provided inside the main body side-by-side in the horizontal direction, and pipeline bottom ends corresponding to the plurality of airflow pipelines are confined inside the main body; and the plurality of air blowing ports are uniformly provided on the plurality of airflow pipelines, and face and extend through a same horizontal side face of the main body.

Specifically, referring to FIGS. 5 to 8, the blowing mixing component specifically comprises three air inlets, three airflow pipelines, and eighteen circular air blowing ports. The three airflow pipelines are provided inside the main body side-by-side in the horizontal direction, each airflow pipeline respectively corresponds to one air inlet, and each airflow pipeline is provided with six air blowing ports. A horizontal distance between the three airflow pipelines is 7 mm, a distance between each two adjacent air blowing ports of the six air blowing ports provided on each airflow pipeline is 10 mm, each air blowing port has a diameter of 0.5 mm, each air blowing port has an air blowing flow of about 1 L/min, and each air blowing port has an air blowing duration of about 5 s. In addition, a distance between each the air blowing port and the smear is 15 mm.

It should be noted that in the embodiments of the disclosure, the number of the air blowing ports, the layout of the air blowing ports, the strength of the airflow, the air blowing duration, the distance between each air blowing port and the smear, the shape of the air blowing port, the number of the air inlets, the number of the air blowing control valves, etc. may be designed according to actual requirements, which are not limited by the embodiments of the disclosure.

It may be understood that in the embodiments of the disclosure, if the blowing mixing component comprises too many air blowing ports, the air source must provide a large airflow to support each air blowing port to blow air together, consuming a large amount of air. To solve the problem of large air consumption, the air blowing mechanism may be modified in such a way that, an additional air blowing control valve may be provided to control some of the air blowing ports separately, and accordingly, the air source only needs to provide a relatively small airflow to support the air blowing ports to blow air, thereby reducing the air consumption. In addition, if there are a plurality of air blowing control valves for controlling a plurality of air blowing ports, each control valve may be opened in sequence for a period.

As an example, referring to FIG. 9, the blowing mixing component comprises eighteen air blowing ports and three air blowing control valves, wherein each control valve actually controls six air blowing ports on an airflow pipeline, and the three air blowing control valves are all connected to the air source. During air blowing mixing, a first air blowing control valve may be opened first, air blowing mixing is performed for 10 s and the first air blowing control valve is then closed; a second air blowing control valve is then opened, air blowing mixing is performed for 10 s and the second air blowing control valve is then closed; thereafter, a third air blowing control valve is opened, and air blowing mixing is performed for 10 s and the third air blowing control valve is then closed. Of course, a duration for which each air blowing control valve is opened for performing air blowing mixing may be set independently according to actual requirements, and may be specifically set within a range of 1 s to 30 s. In addition, each air blowing control valve may also be opened cyclically, that is, air blowing mixing may be performed in multiple cycles.

It should be noted that in the embodiments of the disclosure, a small number of air blowing ports may also be used to reduce air consumption. In order to cover the smear uniformly with the staining reagent and the buffer solution by means of the small number of air blowing ports, the blowing mixing component may be controlled to move.

Specifically, in some embodiments of the disclosure, the air blowing mechanism may further comprise a motion control component connected to the blowing mixing component, and the motion control component being configured to control the blowing mixing component to rotate about an axis of the blowing mixing component itself and/or perform a translational movement in the horizontal direction.

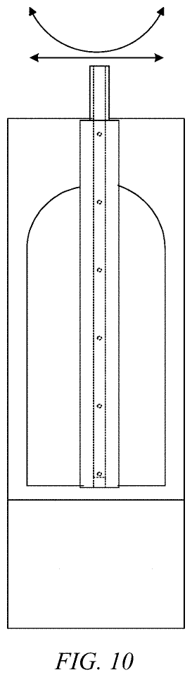

As an example, referring to FIG. 10, the blowing mixing component comprises an airflow pipeline provided with six air blowing ports, and the motion control component may control the blowing mixing component to rotate left and right about an axis of the blowing mixing component itself, so that not only the area on the smear that directly faces the blowing mixing component may be blown by the air blowing ports, but other areas on the smear may also be blown by the air blowing ports during rotation.

It should be noted that in the embodiments of the disclosure, the motion control component controls the blowing mixing component to rotate 60-150 degrees. In actual use, if the air blowing ports are near the smear, the motion control component may control the blowing mixing component to rotate a large rotation angle to ensure that all the areas on the smear can be blown by the air blowing ports. For example, the air blowing ports of the blowing mixing component directly face the central position of the smear, the motion control component controls the blowing mixing component to rotate 150 degrees leftwards from the central position and then return to the central position, then rotate 150 degrees rightwards and then return to the central position, and continually rotate in this way. If the air blowing ports are far from the smear, the motion control component may control the blowing mixing component to rotate a small rotation angle to ensure that all the areas on the smear can be blown by the air blowing ports.

As an example, referring to FIG. 10, the blowing mixing component comprises an airflow pipeline provided with six air blowing ports, all of which directly face the smear, the motion control component may control the blowing mixing component to move left and right in a horizontal direction, and a specific moving range and a specific moving speed may be customized. A moving distance from left to right, that is, the moving range, is required to cover the whole smear, so that all the areas on the smear can be blown by the air blowing ports during translation.

It may be understood that in the embodiments of the disclosure, the smear preparation machine needs to perform dripping and staining with related reagents before using the air blowing mechanism to perform air blowing mixing on the smear.

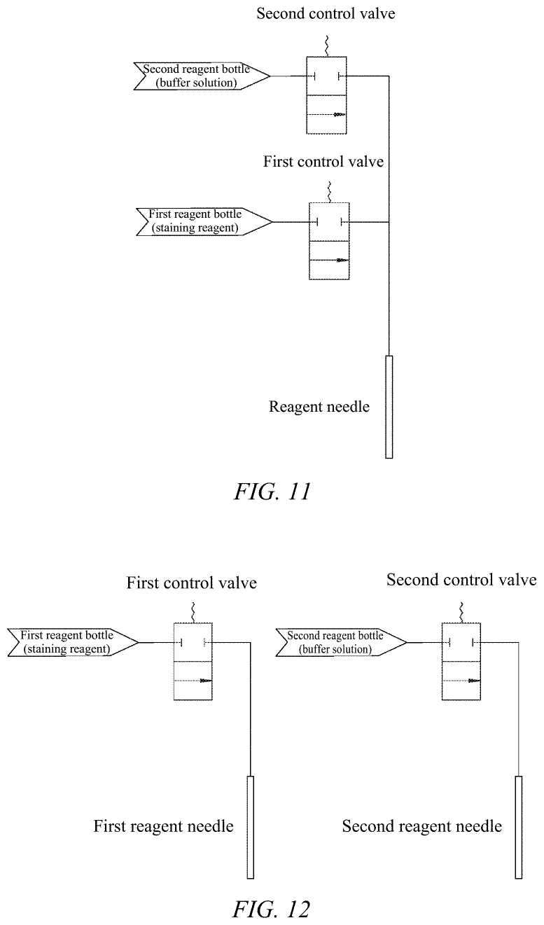

Referring to FIG. 11, in an embodiment, the dripping and staining mechanism 5 comprises a first control valve, a first reagent bottle, a second control valve, a second reagent bottle and a reagent needle, wherein the first control valve is connected to the first reagent bottle and the reagent needle respectively, and the second control valve is connected to the second reagent bottle and the reagent needle respectively; and the reagent needle is configured to drip the staining reagent from the first reagent bottle when the first control valve is opened, and to drip the buffer solution from the second reagent bottle when the second control valve is opened.

It should be noted that in the embodiment of the disclosure, the dripping and staining mechanism 5 may drip the staining reagent and the buffer solution to the smear by means of one reagent needle. Specifically, the dripping and staining mechanism 5 may drip the staining reagent to the smear by means of a reagent needle, and then drip the buffer solution to the smear by means of the reagent needle.

Referring to FIG. 12, in an embodiment, the dripping and staining mechanism 5 comprises a first control valve, and a first reagent bottle and a first reagent needle which are connected to the first control valve, wherein the first reagent needle is configured to drip the staining reagent from the first reagent bottle when the first control valve is opened; and the dripping and staining mechanism 5 further comprises a second control valve, and a second reagent bottle and a second reagent needle which are connected to the second control valve, wherein the second reagent needle is configured to drip the buffer solution from the second reagent bottle when the second control valve is opened.

It should be noted that in the embodiment of the disclosure, the dripping and staining mechanism 5 may drip the staining reagent and the buffer solution to the smear by means of two reagent needles. Specifically, the dripping and staining mechanism 5 may drip the staining reagent to the smear by means of the first reagent needle, and then drip the buffer solution to the smear by means of the second reagent needle.

It should be noted that in the embodiments of the disclosure, the dripping and staining mechanism 5 may control a difference between the time when the staining reagent is dripped to the smear and the time when the buffer solution is dripped to the smear during the staining process. For example, after the staining reagent is dripped to the smear for one minute, the buffer solution is dripped to the smear, which is not limited by the embodiments of the disclosure.

It should be noted that dripping and staining may be performed on the smear according to a first dripping and staining solution or a second dripping and staining solution at present. In the first dripping and staining solution, the dripping and staining mechanism 5 only needs to use a specific staining reagent and a buffer solution to perform one dripping and staining on the smear, and the blowing mixing is then performed. Regarding this solution, the above staining reagent is this specific staining reagent. The two dripping and staining mechanisms 5 above shown in FIGS. 11 and 12 are specific mechanisms for the first dripping and staining solution, which means that the dripping and staining mechanism 5 only uses the specific staining reagent and the buffer solution to perform dripping and staining once. In the second dripping and staining solution, the smear needs to be stained twice. Regarding this solution, the above staining reagent actually comprises a first staining reagent, and a mixed staining reagent formed by mixing a second staining reagent and a buffer solution. It may be understood that the first staining reagent may be the same as or different from the second staining reagent. In an implementation, the first staining reagent is Wright-Giemsa stain, the second stain is Giemsa stain, or the first staining reagent and the second stain are both Wright-Giemsa stain. The dripping and staining mechanism 5 uses the first staining reagent and the buffer solution to perform a primary dripping and staining on the smear and the blowing and mixing is then performed; thereafter, a secondary staining is performed by using the mixed staining reagent in a certain way. The dripping and staining mechanism 5 used in the second dripping and staining solution is described in details as follows.

In an embodiment of the disclosure, the staining reagent comprises a first staining reagent, and a mixed staining reagent formed by mixing a second staining reagent and a buffer solution; the smear preparation machine further comprises a liquid removing mechanism; wherein the liquid removing mechanism is configured to remove the first staining reagent and the buffer solution from the smear, after the dripping and staining mechanism 5 performs a first staining on the smear by using the first staining reagent and the buffer solution; and the dripping and staining mechanism 5 is further configured to drip the mixed staining reagent to the smear to perform a second staining on the smear, after the liquid removing mechanism removes the first staining reagent and the buffer solution from the smear.

It may be understood that in the embodiment of the disclosure, when two kinds of staining reagents are comprised, the air blowing mechanism performs the blowing mixing after the first staining reagent and the buffer solution are dripped to the smear.

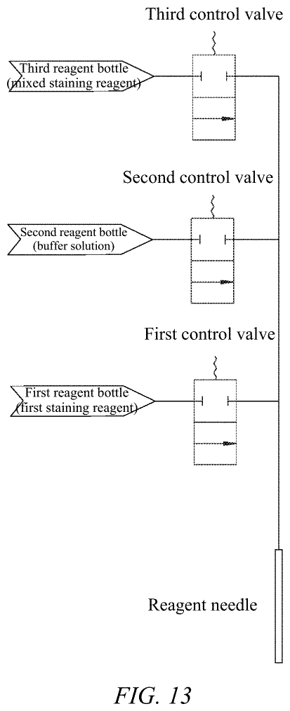

Referring to FIG. 13, the dripping and staining mechanism 5 comprises a first control valve, a first reagent bottle, a second control valve, a second reagent bottle, a third control valve, a third reagent bottle, and a reagent needle, wherein the first control valve is connected to the first reagent bottle and the reagent needle respectively, the second control valve is connected to the second reagent bottle and the reagent needle respectively, and the third control valve is connected to the third reagent bottle and the reagent needle respectively; and the reagent needle is configured to drip the first staining reagent from the first reagent bottle when the first control valve is opened, to drip the buffer solution from the second reagent bottle when the second control valve is opened, to drip the mixed staining reagent from the third reagent bottle when the third control valve is opened.

It should be noted that in an embodiment of the disclosure, the dripping and staining mechanism 5 may drip the first staining reagent, the buffer solution and the mixed staining reagent to the smear by means of one reagent needle. Specifically, the dripping and staining mechanism 5 may drip the first staining reagent and the buffer solution to the smear respectively by means of the reagent needle, and after the air blowing mechanism performs the blowing mixing on the first staining reagent and the buffer solution on the smear to perform the primary staining and the liquid removing mechanism removes the waste mixed liquid, the dripping and staining mechanism 5 drips the mixed staining reagent to the smear by means of the reagent needle to perform the secondary staining.

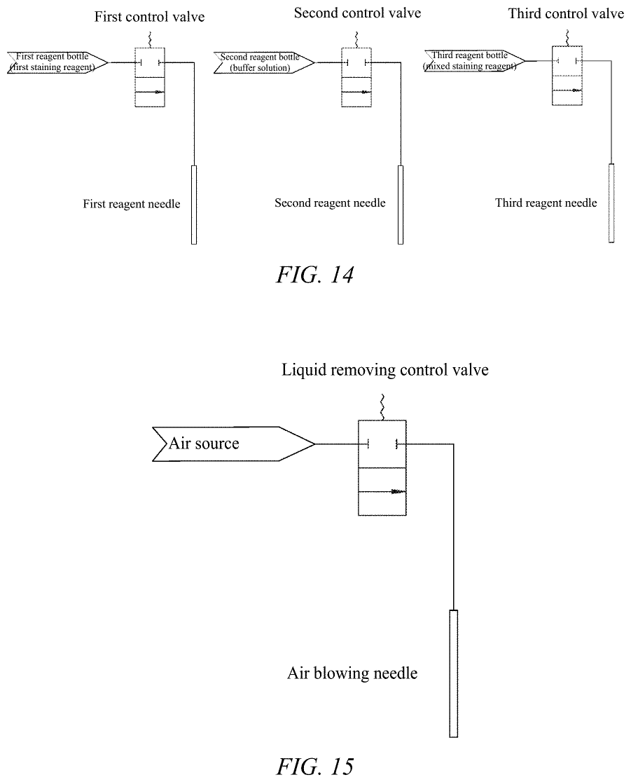

Referring to FIG. 14, a dripping and staining mechanism 5 comprises a first control valve, and a first reagent bottle and a first reagent needle which are connected to the first control valve, the first reagent needle being configured to drip the first staining reagent from the first reagent bottle when the first control valve is opened; the dripping and staining mechanism 5 further comprises a second control valve, and a second reagent bottle and a second reagent needle which are connected to the second control valve, the second reagent needle being configured to drip the buffer solution from the second reagent bottle when the second control valve is opened; and the dripping and staining mechanism 5 further comprises a third control valve, and a third reagent bottle and a third reagent needle which are connected to the third control valve, the third reagent needle being configured to drip the mixed staining reagent from the third reagent bottle when the third control valve is opened. It should be noted that in embodiments of the disclosure, the dripping and staining mechanism 5 may drip the first staining reagent, the buffer solution and the mixed staining reagent to the smear by means of three reagent needles. Specifically, the dripping and staining mechanism 5 may drip the first staining reagent to the smear by means of a first reagent needle first, and then drip the buffer solution to the smear by means of a second reagent needle, and after the air blowing mechanism performs the blowing and mixing on the first staining reagent and the buffer solution on the smear to perform the primary staining and the liquid removing mechanism removes the waste mixed liquid, the dripping and staining mechanism 5 further drips the mixed staining reagent to the smear by means of a third reagent needle to perform the secondary staining.

In an embodiment of the disclosure, the liquid removing mechanism may be the air blowing mechanism. Referring to FIG. 15, the liquid removing mechanism, i.e., the air blowing mechanism further comprises a liquid removing control valve, and an air source and an air blowing needle which are connected to the liquid removing control valve, wherein the air blowing needle is configured to blow off the first staining reagent and the buffer solution from the smear by using an airflow provided by the air source when the liquid removing control valve is opened.

It should be noted that in an embodiment of the disclosure, if the liquid removing mechanism is the air blowing mechanism, the air blowing mechanism not only comprises the above related module capable of realizing air blowing mixing, but also comprises a module using air blowing to remove liquid. In the air blowing mechanism, the air source connected to the air blowing control valve and the air source connected to the liquid removing control valve may be the same module or two independent modules, which is not limited in the embodiments of the disclosure.

In an embodiment of the disclosure, the liquid removing mechanism may also be a flipping mechanism, which is connected to the slide loading mechanism and is configured to flip the slide loading mechanism to cause the first staining reagent and the buffer solution to drip off the smear.

It may be understood that in an embodiment of the disclosure, the smear is loaded on the slide loading mechanism, the flipping mechanism may control the slide loading mechanism to flip by a certain angle, for example, by 90 degrees, and then the smear is perpendicular to a horizontal plane such that the first staining reagent and the buffer solution on the smear drips off the smear naturally. The flipping angle is not specifically limited in the embodiments of the disclosure. In an embodiment of the disclosure, the smear preparation machine stains the smear according to the first dripping and staining solution or the second dripping and staining solution, and after the stained smear is prepared, the stained smear may be washed and dried. Accordingly, the smear preparation machine further comprises a washing mechanism configured to use deionized water to wash the stained smear, and a drying mechanism configured to air-dry the smear after being washed.

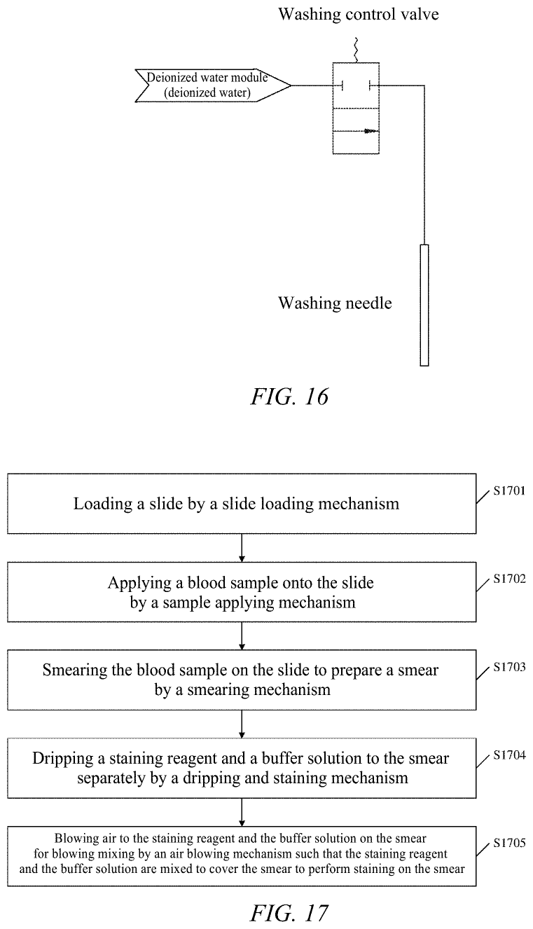

Referring to FIG. 16, the washing mechanism comprises: a deionized water module configured to provide the deionized water, a washing needle configured to output the deionized water to wash the stained smear, and a washing control valve configured to control the flowing of the deionized water to the washing needle, the washing control valve being connected to the deionized water module and the washing needle respectively. When the washing control valve is opened, the deionized water provided by the deionized water module flows to the washing needle and flows out of the washing needle, and then rushes to the stained smear to wash same.

It should be noted that in an embodiment of the disclosure, the drying mechanism may specifically be a fan, and of course, may also be other devices capable of realizing a drying function, which is not specifically limited in the embodiments of the disclosure.

It should be noted that in an embodiment of the disclosure, the above related mechanisms of the smear preparation machine may be provided at designated positions, the slide loading mechanism for loading a smear may move the smear to different stations sequentially according to a staining preparation sequence, and the mechanisms provided at the positions corresponding to the stations execute related operations. Of course, the related mechanisms of the above smear preparation machine may also be provided in the smear preparation machine by means of specific movable connecting components, and each is rotated to a position above the smear when the related operation is executed.

Based on the above smear preparation machine, embodiments of the disclosure provide two corresponding sample staining solutions, and a first dripping and staining solution and a second dripping and staining solution are described in details as follows.

FIG. 17 is a schematic diagram of a sample staining process performed by a smear preparation machine according to the first dripping and staining solution provided in an embodiment of the disclosure. As shown in FIG. 17, the method mainly comprises the following steps.

At S1701, a slide is loaded by a slide loading mechanism.

In an embodiment of the disclosure, the smear preparation machine comprises a slide loading mechanism 2, and the smear preparation machine may load and fix the slide by the slide loading mechanism 2.

At S1702, a blood sample is applied onto the slide by a sample applying mechanism.

In an embodiment of the disclosure, the smear preparation machine comprises a sample applying mechanism 3, and the smear preparation machine may apply the blood sample onto the slide loaded on the slide loading mechanism 2 by the sample applying mechanism 3. In addition, the smear preparation machine further comprises a sample extracting mechanism 1, and sample aspiration may be performed by a sampling device of the sample extracting mechanism 1 before the blood sample is applied onto the slide by the sample applying mechanism 2.

At S1703, the blood sample on the slide is smeared to prepare a smear by a smearing mechanism.

In an embodiment of the disclosure, the smear preparation machine applies the blood sample onto the slide by the sample applying mechanism 3, and then further smears the blood sample on the slide to prepare a smear by the smearing mechanism 4.

At S1704, a staining reagent and a buffer solution are separately dripped onto the smear by a dripping and staining mechanism.

In an embodiment of the disclosure, the smear preparation machine drips the staining reagent and the buffer solution to the smear separately by the dripping and staining mechanism 5 after preparing the smear by the smearing mechanism 4.

It should be noted that in an embodiment of the disclosure, regarding the first dripping and staining solution, only a specific staining reagent and a buffer solution need to be used to perform dripping and staining on the smear once, which means that the staining reagent only comprises one kind of staining reagent.

Referring to FIG. 11, in an embodiment of the disclosure, the smear preparation machine may move the smear to a position below a reagent needle by the slide loading mechanism 2, and then control a first control valve of the dripping and staining mechanism 5 to be opened, so that the staining reagent in a first reagent bottle is dripped to the smear by means of the reagent needle of the dripping and staining mechanism 5, and after 0.8 ml (which may be set as 0.5 ml-1 ml) of the staining reagent is dripped, control the first control valve to be closed and after staining is performed for 1 min (which may be set as 0.5 min-3 min), control a second control valve to be opened, so that the buffer solution in a second reagent bottle is dripped to the smear by means of the reagent needle of the dripping and staining mechanism 5, and after 1.6 ml (which may be set as 1 ml-2 ml) of the buffer solution is dripped, control the second control valve to be closed.

Referring to FIG. 12, in an embodiment of the disclosure, the dripping and staining mechanism 5 of the smear preparation machine may comprise a first reagent needle and a second reagent needle. Regarding this structure, similar to the dripping and staining mode corresponding to FIG. 11, the smear preparation machine may move the smear to a position below the first reagent needle by means of the slide loading mechanism 2 and drip the staining reagent to the smear, and then move the smear to a position below the second reagent needle by means of the slide loading mechanism 2, so as to drip the buffer solution to the smear by means of the second reagent needle of the dripping and staining mechanism 5. A specific amount and duration of dripping and staining are similar to those of the above dripping and staining solution corresponding to FIG. 11, which are not limited in the embodiments of the disclosure.

At S1705, air is blown to the staining reagent and the buffer solution on the smear for blowing mixing by an air blowing mechanism such that the staining reagent and the buffer solution are mixed to cover the smear to perform staining on the slide.

In an embodiment of the disclosure, the smear preparation machine drips the staining reagent and the buffer solution to the smear by the dripping and staining mechanism 5, and then further blows air to the staining reagent and the buffer solution on the smear for blowing mixing by the air blowing mechanism such that the staining reagent and the buffer solution are mixed to uniformly cover the smear to perform staining on the smear.

Specifically, in an embodiment of the disclosure, the smear preparation machine conveys an airflow provided by an air source to an blowing mixing component by means of opening an air blowing control valve in the air blowing mechanism, then blows the airflow toward the staining reagent and the buffer solution on the smear by means of a plurality of air blowing ports provided on at least one airflow pipeline in the blowing mixing component, and then controls the air blowing control valve to be closed after performing air blowing mixing for 10 s (which may be set as 5 s-30 s), such that the staining reagent and the buffer solution are mixed and uniformly cover the smear to perform one staining. A staining duration is specifically 5 min (which may be set as 3 min-10 min).

It should be noted that in an embodiment of the disclosure, the smear preparation machine performs the blowing mixing on the staining reagent and the buffer solution on the smear by the air blowing mechanism such that the staining reagent and the buffer solution are mixed and uniformly cover the smear so as to perform one staining on the smear, and then may further perform the following steps of using deionized water to wash the stained smear by a washing mechanism, and air-drying the smear after being washed by a drying mechanism.

Referring to FIG. 16, in an embodiment of the disclosure, the smear preparation machine may move the stained smear to a position below a washing needle by the slide loading mechanism 2 and control a washing control valve to be opened, such that the deionized water in a deionized water module flows to the washing needle, and the washing needle can wash the staining reagent and the buffer solution on the smear. After washing is completed, the smear preparation machine may move the smear after being washed to the drying mechanism such as a fan by the slide loading mechanism 2, so as to perform air-drying by the drying mechanism.

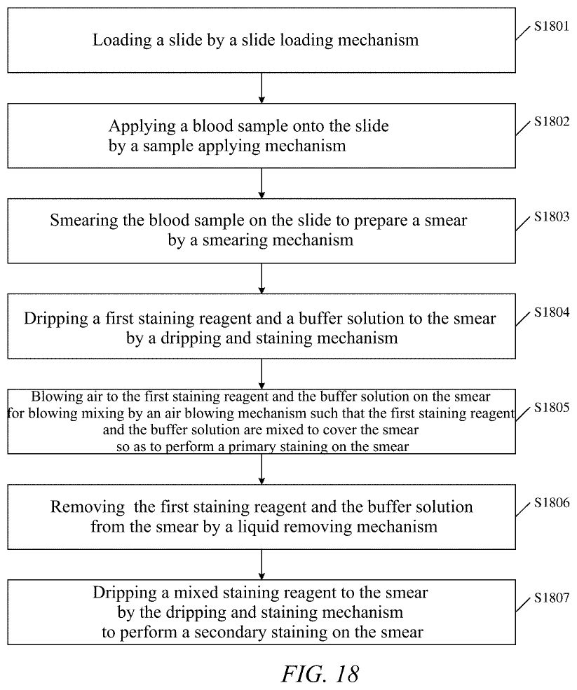

FIG. 18 is a schematic diagram of a sample staining process performed by a smear preparation machine according to a second dripping and staining solution provided in an embodiment of the disclosure. As shown in FIG. 18, the method mainly comprises the following steps.

At S1801, a slide is loaded by a slide loading mechanism.

At S1802, a blood sample is applied onto the slide by a sample applying mechanism.

At S1803, the blood sample on the slide is smeared to prepare a smear by a smearing mechanism.

In the embodiments of the disclosure, steps S1801-S1803 executed by the smear preparation machine with the slide loading mechanism 2, the sample applying mechanism 3 and the smearing mechanism 4 are the same as the above steps S1701-S1703, which will not be described in further detail here.

At S1804, a first staining reagent and a buffer solution are dripped to the smear by a dripping and staining mechanism.

In an embodiment of the disclosure, the smear preparation machine drips the first staining reagent and the buffer solution to the smear separately by the dripping and staining mechanism 5 after preparing the smear by the smearing mechanism 4.

It should be noted that in an embodiment of the disclosure, regarding the second dripping and staining solution, the dripping and staining mechanism 5 needs to perform dripping and staining twice, the staining reagent comprises the first staining reagent, and a mixed staining reagent formed by mixing a second staining reagent and a buffer solution, i.e., two kinds of staining reagents.

Referring to FIG. 13, in an embodiment of the disclosure, the smear preparation machine may move the smear to a position below a reagent needle by the slide loading mechanism 2, and then control a first control valve of the dripping and staining mechanism 5 to be opened, so that the first staining reagent in a first reagent bottle is dripped to the smear by means of the reagent needle of the dripping and staining mechanism 5, and after 0.8 ml (which may be set as 0.5 ml-1 ml) of the first staining reagent is dripped, control the first control valve to be closed, and after staining is performed for 3 min (which may be set as 1 min-5 min), control a second control valve to be opened, so that the buffer solution in a second reagent bottle is dripped to the smear by means of the reagent needle of the dripping and staining mechanism 5, and after 0.8 ml (which may be set as 0.5 ml-1 ml) of the buffer solution is dripped, control the second control valve to be closed.

Referring to FIG. 14, in an embodiment of the disclosure, the dripping and staining mechanism 5 of the smear preparation machine may comprise a first reagent needle, a second reagent needle and a third reagent needle. Regarding this structure, similar to the dripping and staining mode corresponding to FIG. 13, the smear preparation machine may move the smear to a position below the first reagent needle by the slide loading mechanism 2 and drip the first staining reagent to the smear, and then move the smear to a position below the second reagent needle by the slide loading mechanism 2, so as to drip the buffer solution to the smear by means of the second reagent needle of the dripping and staining mechanism 5. A specific amount and duration of dripping and staining are similar to those of the above dripping and staining solution corresponding to FIG. 13, which are not limited in the embodiments of the disclosure.

At S1805, air is blown to the first staining reagent and the buffer solution on the smear for blowing mixing by an air blowing mechanism such that the first staining reagent and the buffer solution are mixed to cover the smear so as to perform a primary staining on the smear.

In an embodiment of the disclosure, the smear preparation machine drips the first staining reagent and the buffer solution to the smear by the dripping and staining mechanism 5, and then performs air blowing mixing on the first staining reagent and the buffer solution on the smear by the air blowing mechanism such that the first staining reagent and the buffer solution are mixed to uniformly cover the smear to perform the primary staining on the smear, which is the same as the above step S1705, they are different only in that what needs to be mixed now is the first staining reagent and the buffer solution, and in addition, a staining duration after the blowing mixing may be set within 3 min-5 min, which will not be described in further detail here.

At S1806, the first staining reagent and the buffer solution are removed from the smear by a liquid removing mechanism.

In an embodiment of the disclosure, the liquid removing mechanism may be the above air blowing mechanism or a flipping mechanism. The smear preparation machine removes the first staining reagent and the buffer solution on the smear by the liquid removing mechanism after performing the primary staining on the smear by means of the air blowing mechanism.

Referring to FIG. 15, the air blowing mechanism comprises a liquid removing control valve, and an air source and an air blowing needle which are connected to the liquid removing control valve. The smear preparation machine may move the smear to a position below the air blowing needle by the slide loading mechanism 2, and then control the liquid removing control valve to be opened, and an airflow provided by the air source is led to the air blowing needle by means of the liquid removing control valve, so that the airflow blown out from the air blowing needle blows off the first staining reagent and the buffer solution from the smear.

It should be noted that in an embodiment of the disclosure, the liquid removing mechanism may also be a flipping mechanism, which is mechanically connected to the slide loading mechanism 2, and which may control the slide loading mechanism 2 to tilt a certain angle from a horizontal direction, for example, directly control the slide loading mechanism 2 to tilt 90 degrees, that is, perpendicular to a horizontal plane, such that the mixed liquid of the first stain and the buffer solution is dripped off the smear, thereby removing the mixed liquid.

At S1807, the mixed staining reagent is dripped to the smear by the dripping and staining mechanism to perform a secondary staining on the smear.

In an embodiment of the disclosure, the smear preparation machine removes the first staining reagent and the buffer solution from the smear by the liquid removing mechanism, and then drips the mixed staining reagent onto the smear by the dripping and staining mechanism 5 to perform the secondary staining on the smear.

Referring to FIG. 13, in an embodiment of the disclosure, during the secondary staining, the smear preparation machine may move the smear to a position below a reagent needle by the slide loading mechanism 2, and control a third control valve of the dripping and staining mechanism 5 to be opened, such that the mixed staining reagent (a ratio of a second staining reagent to a buffer solution is about 1:19) in a third reagent bottle is dripped to the smear by means of the reagent needle of the dripping and staining mechanism 5, and after 0.8 ml (which may be set as 0.5 ml-1 ml) of the mixed staining reagent is dripped, control the third control valve to be closed and perform staining for 18 min (which may be set as 10 min-20 min).

Referring to FIG. 14, in an embodiment of the disclosure, the dripping and staining mechanism 5 of the smear preparation machine may comprise a first reagent needle, a second reagent needle and a third reagent needle. Regarding this structure, the smear preparation machine may move the smear to a position below the third reagent needle by the slide loading mechanism 2, so as to drip the mixed staining reagent to the smear by means of the third reagent needle of the dripping and staining mechanism 5. A specific amount and duration of dripping and staining are similar to those of the above dripping and staining solution corresponding to FIG. 13, which are not limited in the embodiments of the disclosure.

In an embodiment of the disclosure, the smear preparation machine drips the mixed staining reagent onto the smear by the dripping and staining mechanism 5 to perform the secondary staining on the smear, and then may further perform the following steps of using deionized water to wash the smear after being subjected to the secondary staining by a washing mechanism, and air-drying the smear after being washed by a drying mechanism. A specific process of washing and drying the smear after being subjected to the secondary staining by the smear preparation machine with the washing mechanism and the drying mechanism is the same as the above process of finally performing washing and drying by using the first dripping and staining solution, which will not be described in further detail here.

It may be understood that in the prior art, a sample is usually stained manually in a dripping and staining mode, which is inefficient. Moreover, during a staining process, a staining reagent and a buffer solution are usually mixed by means of balloon blowing, so that the mixed liquid may only cover the smear locally and it is difficult to uniformly cover the whole smear. Compared with the prior art, the smear preparation machine provided by the embodiments of the disclosure may use a dripping and staining mode to stain a sample in a fully automated manner, so as to improve the staining efficiency. Furthermore, the air blowing mechanism of the smear preparation machine may allow staining liquid to be mixed uniformly and completely cover the smear, thereby realizing uniform staining and thus improve the staining effect.

Specific examples are used above to explain the disclosure, but they are merely used to help understand the disclosure and not to limit the disclosure. For those skilled in the art, changes may be made to the specific embodiments described above in accordance with the concept of the disclosure.

In the technical solutions of embodiments of the disclosure, a smear preparation machine comprises: a slide loading mechanism configured to load a slide, a sample applying mechanism configured to apply a blood sample onto the slide, a smearing mechanism configured to smear the blood sample on the slide to prepare a smear, a dripping and staining mechanism configured to drip a staining reagent and a buffer solution to the smear, and an air blowing mechanism configured to blow air to the staining reagent and the buffer solution on the smear for blowing mixing, such that the staining reagent and the buffer solution are mixed and cover the smear to perform staining on the smear. The smear preparation machine provided by the embodiments of the disclosure may use a dripping and staining mode to stain a sample in a fully automated manner, so as to improve the staining efficiency. Furthermore, the air blowing mechanism of the smear preparation machine may allow staining liquid to be mixed uniformly and completely cover the smear, thereby realizing uniform staining and thus improve the staining effect.

1. A smear preparation machine, comprising:
a slide loading mechanism configured to load a slide,
a sample applying mechanism configured to apply a blood sample onto the slide,
a smearing mechanism configured to smear the blood sample on the slide to prepare a smear,
a dripping and staining mechanism configured to drip a staining reagent and a buffer solution to the smear, and
an air blowing mechanism configured to blow air to the staining reagent and the buffer solution on the smear for blowing mixing, such that the staining reagent and the buffer solution are mixed and cover the smear to perform staining on the smear.

2. The smear preparation machine of claim 1, wherein the air blowing mechanism comprises an air source, a blowing mixing component and an air blowing control valve, wherein the air blowing control valve is connected to the air source and the blowing mixing component respectively; wherein
the air source is configured to provide an airflow; and
the blowing mixing component is configured to blow the airflow provided by the air source to the staining reagent and the buffer solution to perform the blowing mixing when the air blowing control valve is opened.

3. The smear preparation machine of claim 2, wherein the blowing mixing component comprises at least one air inlet, at least one airflow pipeline, and a plurality of air blowing ports, wherein
the plurality of air blowing ports are provided on the at least one airflow pipeline;
the at least one air inlet is connected to the air blowing control valve and the at least one airflow pipeline respectively, the at least one air inlet is configured to receive the airflow when the air blowing control valve is opened, so as to cause the airflow to flow to the at least one airflow pipeline; and
the plurality of air blowing ports are configured to blow the airflow, which enters into the at least one airflow pipeline, to the staining reagent and the buffer solution on the smear.

4. The smear preparation machine of claim 3, wherein the blowing mixing component further comprises a main body, the at least one airflow pipeline comprises a plurality of airflow pipelines, each airflow pipeline corresponds to one air inlet, and each air inlet is provided outside the main body in a horizontal direction;
the plurality of airflow pipelines are provided inside the main body side-by-side in a horizontal direction, and pipeline bottom ends corresponding to the plurality of airflow pipelines are confined inside the main body; and
the plurality of air blowing ports are uniformly provided on the plurality of airflow pipelines, and face and extend through a same horizontal side face of the main body.

5. The smear preparation machine of claim 2, wherein the air blowing mechanism further comprises a motion control component connected to the blowing mixing component, and the motion control component is configured to control the blowing mixing component to rotate about an axis of the blowing mixing component itself and/or to perform a translational movement in a horizontal direction.

6. The smear preparation machine of claim 5, wherein the motion control component is configured to control the blowing mixing component to rotate 60-150 degrees.

7. The smear preparation machine of claim 1, wherein
the dripping and staining mechanism comprises a first control valve, a first reagent bottle, a second control valve, a second reagent bottle and a reagent needle, wherein
the first control valve is connected to the first reagent bottle and the reagent needle respectively, and the second control valve is connected to the second reagent bottle and the reagent needle respectively; and
the reagent needle is configured to drip the staining reagent from the first reagent bottle when the first control valve is opened, and to drip the buffer solution from the second reagent bottle when the second control valve is opened.

8. The smear preparation machine of claim 1, wherein
the dripping and staining mechanism comprises a first control valve, and a first reagent bottle and a first reagent needle which are connected to the first control valve, the first reagent needle being configured to drip the staining reagent from the first reagent bottle when the first control valve is opened; and
the dripping and staining mechanism further comprises a second control valve, and a second reagent bottle and a second reagent needle which are connected to the second control valve, the second reagent needle being configured to drip the buffer solution from the second reagent bottle when the second control valve is opened.

9. The smear preparation machine of claim 1, wherein the staining reagent comprises a first staining reagent, and a mixed staining reagent formed by mixing a second staining reagent and the buffer solution; and the smear preparation machine further comprises a liquid removing mechanism; wherein
the liquid removing mechanism is configured to remove the first staining reagent and the buffer solution from the smear, after the dripping and staining mechanism performs a first staining on the smear by using the first staining reagent and the buffer solution; and
the dripping and staining mechanism is further configured to drip the mixed staining reagent to the smear to perform a second staining on the smear, after the liquid removing mechanism removes the first staining reagent and the buffer solution from the smear.

10. The smear preparation machine of claim 9, wherein
the dripping and staining mechanism comprises a first control valve, a first reagent bottle, a second control valve, a second reagent bottle, a third control valve, a third reagent bottle, and a reagent needle, wherein
the first control valve is connected to the first reagent bottle and the reagent needle respectively, the second control valve is connected to the second reagent bottle and the reagent needle respectively, and the third control valve is connected to the third reagent bottle and the reagent needle respectively; and
the reagent needle is configured to drip the first staining reagent from the first reagent bottle when the first control valve is opened, to drip the buffer solution from the second reagent bottle when the second control valve is opened, and to drip the mixed staining reagent from the third reagent bottle when the third control valve is opened.

11. The smear preparation machine of claim 9, wherein
the dripping and staining mechanism comprises a first control valve, and a first reagent bottle and a first reagent needle which are connected to the first control valve, the first reagent needle being configured to drip the first staining reagent from the first reagent bottle when the first control valve is opened;
the dripping and staining mechanism further comprises a second control valve, and a second reagent bottle and a second reagent needle which are connected to the second control valve, the second reagent needle being configured to drip the buffer solution from the second reagent bottle when the second control valve is opened; and
the dripping and staining mechanism further comprises a third control valve, and a third reagent bottle and a third reagent needle which are connected to the third control valve, the third reagent needle being configured to drip the mixed staining reagent from the third reagent bottle when the third control valve is opened.

12. The smear preparation machine of claim 9, wherein the liquid removing mechanism is the air blowing mechanism or a flipping mechanism, wherein
the air blowing mechanism comprises a liquid removing control valve, and an air source and an air blowing needle which are connected to the liquid removing control valve; the air blowing needle is configured to blow off the first staining reagent and the buffer solution from the smear by using an airflow provided by the air source when the liquid removing control valve is opened; and
the flipping mechanism is connected to the slide loading mechanism for flipping the slide loading mechanism to cause the first staining reagent and the buffer solution to drip off the smear.

13. The smear preparation machine of claim 1, further comprising:
a washing mechanism configured to use deionized water to wash the stained smear, and
a drying mechanism configured to air-dry the stained smear.

14. The smear preparation machine of claim 13, wherein the washing mechanism comprises:
a deionized water module configured to provide the deionized water,
a washing needle configured to output the deionized water to wash the stained smear, and
a washing control valve configured to control the flowing of the deionized water to the washing needle,
wherein the washing control valve is connected to the deionized water module and the washing needle respectively.

15. A sample staining method applicable to a smear preparation machine, the method comprising:
loading a slide by a slide loading mechanism;
applying a blood sample onto the slide by a sample applying mechanism;
smearing the blood sample on the slide to prepare a smear by a smearing mechanism;
dripping a staining reagent and a buffer solution to the smear respectively by a dripping and staining mechanism, and
blowing air to the staining reagent and the buffer solution on the smear for blowing mixing by an air blowing mechanism such that the staining reagent and the buffer solution are mixed to cover the smear to perform staining on the smear.

16. The method of claim 15, wherein after blowing air to the staining reagent and the buffer solution on the smear for blowing mixing by an air blowing mechanism such that the staining reagent and the buffer solution are mixed to cover the smear to perform staining on the smear, the method further comprises:
using deionized water to wash the stained smear by a washing mechanism, and
air-drying the stained smear by a drying mechanism.

17. A sample staining method applicable to a smear preparation machine, the method comprising:
loading a slide by a slide loading mechanism;
applying a blood sample onto the slide by a sample applying mechanism;
smearing the blood sample on the slide to prepare a smear by a smearing mechanism;
dripping a first staining reagent and a buffer solution to the smear by a dripping and staining mechanism;
blowing air to the first staining reagent and the buffer solution on the smear for blowing mixing by an air blowing mechanism such that the first staining reagent and the buffer solution are mixed to cover the smear so as to perform a primary staining on the smear;
removing the first staining reagent and the buffer solution from the smear by a liquid removing mechanism; and
dripping a mixed staining reagent to the smear by the dripping and staining mechanism to perform a secondary staining on the smear.

18. The method of claim 17, wherein after dripping a mixed staining reagent to the smear by the dripping and staining mechanism to perform a secondary staining on the smear, the method further comprises:
using deionized water to wash the smear after being subjected to the secondary staining by a washing mechanism, and
air-drying the smear after being washed by a drying mechanism.

19. The method of claim 17, wherein the step of removing the first staining reagent and the buffer solution from the smear by a liquid removing mechanism comprises:
removing the first staining reagent and the buffer solution from the smear using an airflow by the air blowing mechanism as the liquid removing mechanism; or
flipping the slide loading mechanism by a flipping mechanism as the liquid removing mechanism, to cause the first staining reagent and the buffer solution to drip off the smear.
